(19) United States
(12) Patent Application Publication
(10) Pub. No.: US 2006/0133985 A1
(43) Pub. Date: Jun. 22, 2006

(54) Process and tubular reactor for recovery of chlorine from iron chlorides

(76) Inventors: Thomas J. Buller, Diamondhead, MS (US); Stephen E. Lyke, Wilmington, DE (US); Aaron J. Becker, Wilmington, DE (US); Stephan C. De La Veaux, Wilmington, DE (US); Russell Bertrum Diemer, Wilmington, DE (US); James B. Dunson Jr., Newark, DE (US); James N. Tilton, Landenberg, PA (US); David A. Zimmerman, Wilmington, DE (US); Stephen A. Hallock, Newark, DE (US)

Correspondence Address: E I du Pont de Nemours & Company, Legal Patents, Wilmington, DE, 19898, US

(21) Appl. No.: 10/538,356

(22) PCT Filed: Dec. 12, 2003
(86) PCT No.: PCT/US03/40327

§ 371 Date: Jan. 19, 2006

Related U.S. Application Data
(60) Provisional application No. 60/433,686, filed on Dec. 16, 2002.

(51) Int. Cl. C01B 7/00; B01J 8/04

(52) U.S. Cl. 423/500; 422/196; 422/224

(57) ABSTRACT

The present invention relates to a process for recovering chlorine from a feed stream containing metal chlorides using a tubular reactor wherein a hot oxygen containing gas has an initial velocity such that the resulting velocity of the bulk gas formed from mixing the oxygen containing gas with the metal chloride feed stream and a scrubs feed stream is sufficient to remove wall deposits as fast as such deposits are formed.

### BACKGROUND OF THE INVENTION

This invention relates to a process for the recovery of chlorine from metal chlorides and the conversion of the metal chlorides to metal oxides using a high-velocity tubular reactor.

### BACKGROUND OF THE INVENTION

Many industrial processes designed to convert mineral ores to products of greater purity and value involves an initial step wherein metals in the ore are converted to metal chlorides. The processes for the production of titanium dioxide pigment and for the production of titanium or zirconium metal are examples of such conversion processes where metal values are first converted to metal chlorides.

The conversion of ore metal values to metal chlorides also provides a means to separate iron and other metal chlorides from those of the higher valued chlorides of metals such as titanium, and zirconium. But, there has continued to be the need for a process by which the chloride values from the iron and other metal chlorides considered to be of low value could be recovered. One potential process would use oxygen or oxygen-containing gas at elevated temperature to convert the metal chlorides to metal oxides and chlorine. But, past attempts to develop such a process have been plagued by adhesion of the product metal oxide to the reactor walls which severely limits the reactor utility. This invention uses a tubular reactor where accumulation of adhesive product is prevented through use of high bulk gas velocity and addition of scrubbing media. The scrubbing media is non-reactive solids present in the metal chloride feed and/or non-reactive solids added to the reactor.

Iron chlorides and other metal chlorides are generated as byproducts from industrial processes involving chlorination, for example, in the manufacture of titanium dioxide pigment by the chloride process. These metal chlorides have economic value due to their chlorine content and an economic loss may be incurred by their disposal. Recovery of recyclable elemental chlorine from the metal chlorides has long been sought because of potential economic and environmental benefits. However, economical and practical ways of recovering chlorine from metal chlorides have not been provided by methods known in the art.

For a detailed discussion of the prior art and problems associated with oxidation of FeCl₃ and/or FeCl₂ to iron oxides and chlorine, see Bonsack and Fridman, U.S. Pat. No. 4,540,551, and Becker, et al., U.S. Pat. No. 6,277,354.

Methods for oxidation of iron chloride to chlorine and ferric oxide in a reactor, based on a feed stream comprising ferric chloride vapor, are well known. In practice, however, such methods suffer from the difficulty that in generating solid iron oxide product from the gaseous reactants there is a strong tendency for oxide scale to build up on the reactor walls and on associated equipment. These methods also suffer from the difficulty of requiring that the metal chlorides enter the reactor in the vapor phase, when typical byproduct metal chloride streams contain components that are non-volatile or have high boiling points.

Herriman and Lawrence, U.S. Pat. No. 3,464,792, disclose a process for vapor phase oxidation of a metal halide. The process involves preheating a first gas, that is, an oxidizing gas, the metal halide or an inert gas, using an electric arc device, e.g., gas plasma, to a temperature of at least 2000° C. and then introducing the heated first gas into a reaction zone. A second gas (oxidizing gas, metal halide or inert gas) is introduced to the reaction zone by means of an injection device having a plurality of orifices. The injection device is positioned adjacent to the inlet of the first gas such that the second gas cools material forming on the walls of the injection device and is thereby heated before passing into the reaction zone.

Oxidation of iron chlorides to chlorine and ferric oxide based on a feed comprising solid ferrous chloride is also known. Hsu, in U.S. Pat. No. 4,994,255 discloses a process for oxidizing ferrous chloride to chlorine and ferric oxide, wherein solid ferrous chloride is introduced into a fluidized bed reactor comprised of inert particulate material.

While various processes for recovering chlorine from metal chlorides are generally known, it is still desirable to improve upon these processes to make them more attractive economically as a means to recover and recycle chlorine. Particularly, it would be desirable to have a process for treating metal chlorides to generate chlorine with improvements in reduction of wall scale and pluggage problems, high conversion of the metal chlorides, generation of recyclable chlorine, and ability to recycle unreacted oxygen in a simple reaction system. The present invention provides such a process.

### BRIEF SUMMARY OF THE INVENTION

The present invention is a process for recovering chlorine by oxidizing a stream comprising metal chlorides, comprising the steps of:

(a) feeding a pre-heated oxygen containing gas into one end of a tubular reactor;

(b) contacting the pre-heated oxygen containing gas at temperature T_{Ox} and velocity v_{Ox} and a stream comprising metal chlorides at temperature Tₘₓ and velocity Vₘₓ wherein the metal chlorides are selected from the group consisting of iron chlorides and mixtures of transition, alkali and alkaline-earth metal chlorides existing in the form of entrained solids, entrained liquids, vapors and mixtures thereof;

(c) introducing non-reactive scrubbing media at temperature Tₛ and velocity vₛ into the reactor; and

(d) at least partially reacting the pre-heated oxygen containing gas with the stream comprising metal chlorides, wherein the walls of the tubular reactor are cooled externally to a temperature range of from about 0 to 500° C. and wherein the temperature of the combined oxygen containing gas, metal chlorides and scrubbing media streams is greater than temperature T_{Rx}, which is the minimum temperature required to initiate oxidation of the metal chlorides, and wherein the combination of v_{Ox}, vₘₓ and vₛ provides at least enough energy to the scrubbing media so that the media removes wall deposits as fast as the deposits are formed.

In the present process the walls of the tubular reactor are cooled to a temperature of from 0 to 500° C., and it is more preferred to cool a substantial portion of the walls of the tubular reactor to a temperature of from 250 to 400° C. The walls may be cooled in two or more stages to intermediate temperatures of from 0 to 500° C. or to temperatures from 250 to 400° C.

In the present process it is also preferred that the temperature T_{Rx}, which is the minimum temperature required to initiate oxidation of the metal chlorides, be sustained for at least 0.1 seconds after the pre-heated oxygen-containing gas contacts the stream containing the metal chlorides.

In the present process it is also preferred that scrubbing media is fed into the reactor at one or more positions wherein the positions are selected from the group consisting of (a) one or more positions located between the position where the pre-heated oxygen containing gas enters the reactor and the position where the pre-heated oxygen containing gas and stream comprising metal chlorides are contacted, (b) one or more positions located downstream of the location where the stream comprising metal chlorides is fed into the reactor, and (c) a position or positions where the scrubbing media is fed simultaneously with the stream comprising the metal chlorides. Suitable scrubbing media may be selected from the group consisting of SiO2, ZrO2, TiO2, Fe2O3, beach sand, titanium ore, olivine, garnet, titanium carbide, dolomite, petroleum coke, salt, and like materials. In the present process, the metal chloride stream may be added by a tee mixer, an axial slot, a radial slot, and a coaxial center-feed nozzle.

The present process also includes a tubular reactor useful in the recovery of chlorine from a stream comprising metal chlorides, the reactor having a feed end and an exit end separated by a length of wall having a diameter D and wherein disposed in the wall near the feed end of the reactor are two or more means for feeding two or more feed streams comprising (a) a first stream comprising hot oxygen, (b) a second stream scrubbing media, and (c) a third stream comprising a metal chloride stream wherein the third stream is fed through a third means for feeding or fed simultaneously with the scrubbing media and wherein the reactor includes a means for pre-heating at least one of the feed streams and wherein the diameter D is varied along the length of wall of the reactor and wall temperature is controlled by an external cooling means at least over a portion of the wall's length.

It is preferred that the present reactor have walls cooled by means of a jacket having one or more pair of inlets and outlets through which one or more cooling fluids are circulated to control the wall temperature.

### BRIEF DESCRIPTION OF THE DRAWING(S)

FIG. 1 illustrates a reactor design exemplified in Example 1.

FIG. 2 illustrates a reactor design exemplified in Example 2.

FIG. 3 illustrates one method of introducing a swirl component into the feed stream flows in the reactor.

### DETAILED DESCRIPTION OF THE INVENTION

The present invention is a process and reactor designed to recover chlorine from a stream of chlorides containing iron chlorides and mixtures of transition metal chlorides. One such chloride-containing stream is the waste stream from making titanium tetrachloride from titanium/iron containing ores. For example, in making titanium tetrachloride from ilmenite ores and other iron rich ores one of the by-products is a stream rich in iron chlorides and mixed with other transition metal chlorides. Other metal production processes that would produce similar iron chloride-containing waste streams include such as the processes to recover zirconium, aluminum, vanadium, tantalum, niobium, molybdenum, chromium, tungsten, and nickel from iron-containing ores. The present process is suitable to use to recover the chlorine value from any stream of containing iron chlorides and other metal chlorides. The process comprises the steps of:

(a) feeding a pre-heated oxygen containing gas into one end of a tubular reactor;

(b) contacting the pre-heated oxygen containing gas at temperature T_{Ox} and velocity v_{Ox} with a stream comprising metal chlorides at temperature Tₘₓ and velocity _{Vmx} wherein the metal chlorides are selected from the group consisting of iron chlorides and mixtures of transition, alkali and alkaline-earth metal chlorides existing in the form of entrained solids, entrained liquids, vapors and mixtures thereof;

(c) introducing non-reactive scrubbing media at temperature Tₛ and velocity vₛ into the reactor; and

(d) at least partially reacting the pre-heated oxygen containing gas with the stream comprising metal chlorides, wherein the walls of the tubular reactor are cooled externally to a temperature range of from about 0 to 500° C. and wherein the temperature of the combined oxygen containing gas, metal chlorides and scrubbing media streams is greater than temperature T_{Rx}, the minimum temperature required to initiate oxidation of the metal chlorides and wherein the combination of v_{Ox}, vₘₓ and vₛ provides at least enough energy to the scrubbing media to remove wall deposits as fast as the deposits are formed.

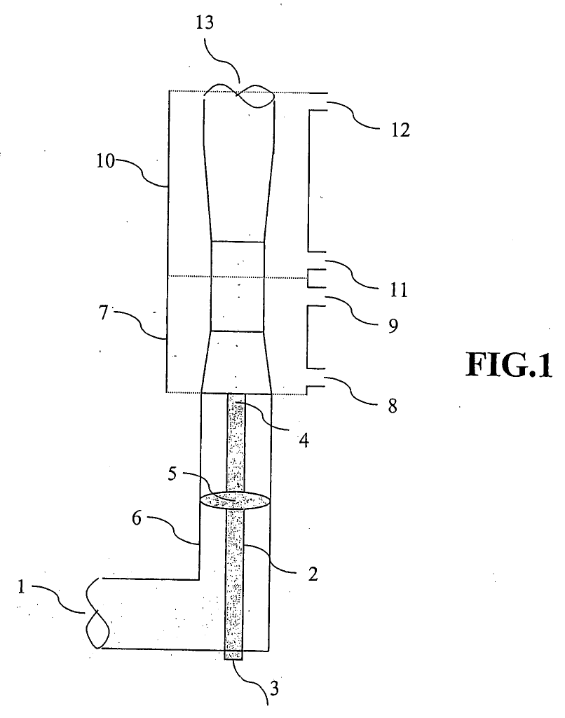

The present invention also includes a reactor that is suitable for use in the present process. The reactor is tubular and has a feed end and an exit end separated by a length of wall having a diameter D and wherein disposed in the wall near the feed end of the reactor are two or more means for feeding two or more feed streams comprising (a) a first stream comprising hot oxygen, (b) a second stream comprising scrubbing media, and (c) a third stream comprising a metal chloride stream wherein the third stream is fed through a third means for feeding or fed simultaneously with the scrubbing media and wherein the reactor includes a means for pre-heating at least one of the feed streams and wherein the diameter D is varied along the length of wall of the reactor and wall temperature is controlled by an external cooling means at least over a portion of the wall's length. Examples of reactors according to the present invention are shown in FIGS. 1, 2, and 3.

In the present process an oxygen-containing gas is pre-heated. The temperature of the pre-heated oxygen-containing gas must be sufficient to attain T_{Rx} upon combination with the metal chloride and scrubs streams, considering the temperatures, compositions and flowrates of those streams as well as heat losses. T_{Rx} will depend upon the composition of the metal chloride-containing stream and typically ranges from 400° C. to 800° C. Useful oxygen pre-heat temperatures would typically be in the range of 1000° C. to 2500° C. The oxygen-containing stream can be heated to temperatures in this range by direct or indirect means including by a burner, a pebble heater, an electrical resistance heater, or a plasma torch.

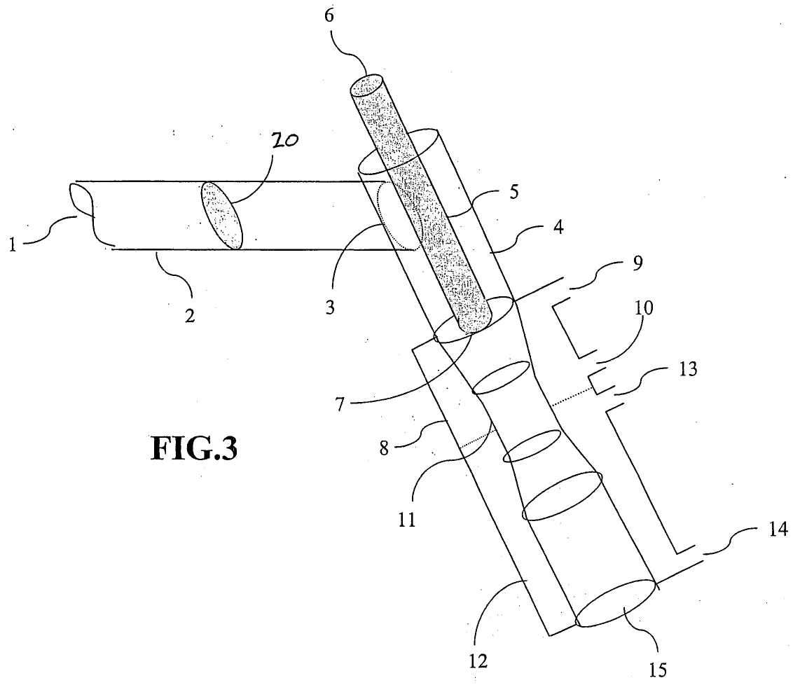

The oxygen-containing gas should contain at least, or more than, the amount of oxygen needed to stoichiometrically oxidize the metal chlorides. It may contain, in addition, inert gases such as nitrogen and argon and/or recycled product gases such as chlorine, carbon monoxide, and carbon dioxide. The velocity of the oxygen-containing gas, V_{Ox}, must be sufficient to ensure that neither the metal chloride reactants nor metal oxide products accumulate on the reactor wall in the feed zone. The minimum V_{Ox} will depend upon the geometry of the feed zone including the methods of introducing the metal chloride and scrubs streams and the presence of swirl. Introducing the oxygen-containing gas with a tangential velocity component can conveniently generate swirl (See FIG. 3, as an example of a method to introduce swirl). The minimum V_{Ox} will also depend upon the bulk temperature and the temperature to which the reactor wall is cooled, within the feed zone. Useful velocities range from 200 ft/s to sonic velocity.

Non-reactive scrubbing media, scrubs, are needed to facilitate removal of wall deposits as fast as they form. The metal chloride stream, as available to the process, may already contain sufficient scrubs. If not, scrubs may be added to that stream or, preferably, introduced to the reactor as a separate stream. Most preferably, the scrubs can be introduced upstream of the metal chloride stream to allow them to mix with and approach the velocity of the pre-heated oxygen-containing gas. A variety of materials and particle sizes may be effective as scrubs. Beach sand or product metal oxide particles in the 1 to 2 mm size range are known to be effective but other materials and particle sizes can be used. The scrubs can be conveniently introduced into the reactor by gravity flow or with a first conveying gas. The first conveying gas can be an inert gas, air or, preferably, oxygen or a recycled oxygen-containing gas. The conveying velocity at the point of scrubs injection should be selected to provide good mixing with the pre-heated oxygen-containing gas stream.

The metal chlorides may be fed as vapors or liquids but, most conveniently, are fed as solids entrained in a second conveying gas. In that case, the temperature of the metal chloride feed stream can range from ambient up to the maximum temperature at which the feed can be conveyed without sticking. The upper end of the temperature range would be most desirable, from an energy conservation standpoint, if the chlorides are already available at that temperature or can be brought to temperature with recovered heat. The second conveying gas can be an inert gas, air, oxygen or, preferably, a recycled oxygen-containing gas. The conveying velocity at the point of metal chloride stream injection should be selected to provide good mixing with the pre-heated oxygen-containing gas stream.

When the scrubbing media are introduced with a first conveying gas and the stream comprising metal chlorides are introduced with a second conveying gas, the combination of the pre-heated oxygen-containing gas and the first and second conveying gases forms a bulk gas in the reactor. Preferably, the bulk gas has a velocity, V_{b}, sufficient to remove wall deposits as fast as such deposits are formed.

The reactor diameter downstream of feed introduction can vary, maintaining adequate velocity to convey the solid reactants and products and to scrub deposits from the walls as fast as they form. The minimum required velocity will be lower when more non-reactive scrubbing media is present but will also depend upon the composition of the metal chloride feed stream, degree of conversion to oxides and the temperature at which the reactor walls are maintained. Without cooling, hard deposits tend to form on the reactor walls, which are difficult to scrub away. Using excessive velocity and wall cooling to minimize deposition causes the temperature of the combined, reacting streams to drop rapidly and also causes excessive pressure drop. To obtain desirable conversion of chlorides to oxides, the combined streams should remain above T_{Rx} for at least 0.1 sec. In the mixing zone, which can be considered to extend at east ten reactor diameters from the point at which the metal chloride and pre-heated oxygen-containing gas streams are combined, the reactor walls are preferably maintained below 150° C. and the velocity is preferably maintained above 200 ft/sec. To facilitate conversion without excessive heat input, the reactor walls, downstream of the mixing zone, are preferably maintained between 150° C. and 500° C. and most preferably between 250° C. and 400° C. The most preferred temperature range is chosen to minimize both condensation of unreacted metal chlorides and reactive deposition of metal oxides. Under these conditions, the velocity of the combined, reacting stream can be allowed to drop to as low as 100 ft/sec. The walls of a final portion of the tubular reactor may be cooled below 150° C., if desired, to further cool the reactor product.

The feed metal chlorides can be conveyed into the reactor from an intermediate storage bin or from a collection device that retrieves them from the process in which they are generated. Downstream of the reactor, the metal chlorides, at least partially converted to chlorine and metal oxides, can be quenched in water to separate the solid products from the chlorine and unreacted oxygen or the separation can be accomplished in suitable dry separation equipment such as cyclones and filters. The chlorine can be recovered from the un-reacted oxygen by suitable means such as liquefaction or adsorption, and the unreacted oxygen can be recycled.

FIG. 1 illustrates a reactor design exemplified in Example 1. In this figure preheated oxygen-containing gas is fed into one end of the tubular reactor at 1. The oxygen-containing gas flows through an annulus formed by the reactor wall 6 and a coaxial metal chloride feed lance 2. Scrub solids are introduced into this annulus at 5. Metal chlorides enter lance 2 at 3 and discharge at 4 downstream of the scrub solids inlet 5. The reaction between the preheated oxygen-containing gas and the metal chlorides starts at 4 and continues down the reactor. In this figure the walls of the reactor downstream of position 4 are externally cooled in two cooling zones 7 and 10. The upstream zone has a secondary pipe 7 surrounding the tubular reactor with cooling media flowing through the annulus formed by the reactor and the secondary pipe. Cooling media enters the cooling zone at 8 and exits at 9. The downstream zone has a secondary pipe 10 surrounding the tubular reactor with cooling media flowing through the annulus formed by the reactor and the secondary pipe. Cooling media enters the cooling zone at 11 and exits at 12. The reactor product discharges from the reactor at 13.

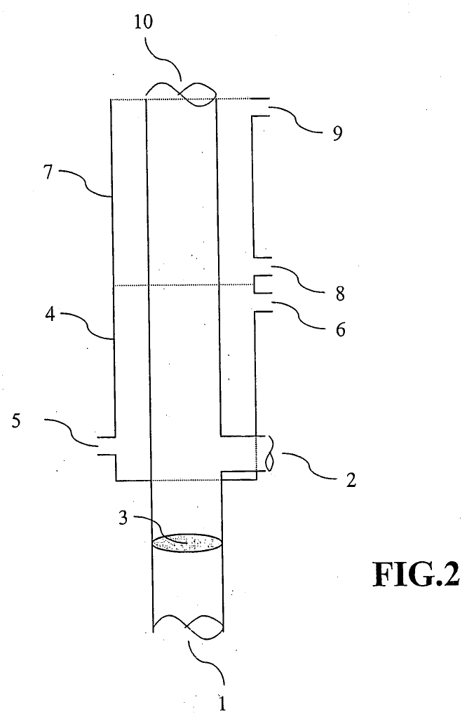

FIG. 2 illustrates a reactor design exemplified in Example 2. In this Figure, preheated oxygen-containing gas is fed into one end of the tubular reactor at 1. Scrub solids enter the reactor and mix with the preheated oxygen-containing gas at 3. Metal chlorides enter the reactor at 2 through a tee mixer downstream of the scrub solids inlet. The reaction between the preheated oxygen-containing gas and the metal chlorides starts at 2 and continues down the reactor. In this figure the walls of the reactor downstream of 2 are externally cooled in two cooling zones 4 and 7. The upstream zone has a secondary pipe 4 surrounding the tubular reactor with cooling media flowing through the annulus formed by the reactor and the secondary pipe. Cooling media enters the cooling zone at 5 and exits at 6. The downstream zone has a secondary pipe 7 surrounding the tubular reactor with cooling media flowing through the annulus formed by the reactor and the secondary pipe. Cooling media enters the cooling zone at 8 and exits at 9. The reactor product discharges from the reactor at 10.

FIG. 3 illustrates one method of introducing a swirl component into the feed stream flows in the reactor. In this figure preheated oxygen-containing gas enters at 1 and flows through feed pipe 2. Scrub solids enter feed pipe 2 downstream of 1. Preheated oxygen-containing gas and scrub solids flow from feed pipe 2 into reactor pipe 4. The centerline of feed pipe 2 is offset from that of reactor pipe 4 to create a tangential entry point 3.

Oxygen-containing gas and scrub solids flow through an annulus formed by the inner wall of the reactor pipe 4 and the outer wall of the coaxial metal chloride feed lance 5. Metal chlorides enter the lance at 6 and discharge at discharge location 7. The reaction between the oxygen-containing gas and the metal chlorides starts at discharge location 7 and continues down the reactor. In this figure the walls of the reactor downstream of discharge location 7 are externally cooled in two cooling zones 8 and 12. The upstream zone has a secondary pipe surrounding the tubular reactor pipe 11 with cooling media flowing through the annulus formed by the reactor and the secondary pipe. Cooling media enters the cooling zone at of the secondary pipe at 9 and exits at 10. The downstream zone has a secondary pipe surrounding the tubular reactor with cooling media flowing through the annulus formed by the reactor and the secondary pipe. Cooling media enters the cooling zone of the secondary pipe at 13 and exits at 14. The reactor product discharges from the reactor at 15.

As shown in FIG. 3, the centerline of feed pipe 2 is offset from that of reactor pipe 4 to create a tangential entry point 3. The tangential entry point created by the positioning of the feed pipe 2 relative to the reactor pipe 4 imparts a swirl to the oxygen-containing gas and scrub solids. The swirl maximizes the effectiveness of the scrub solids in preventing downstream wall deposits by improving the contact of the scrub solids with the reactor wall. The swirl component of the oxygen-containing gas and scrub solids extends into downstream reactor pipe 11.

In a preferred embodiment of the tubular reactor for recovery of chlorine from metal chlorides shown in FIG. 3 the feed pipe 2 is typically refractory-lined to minimize heat loss. The temperature of the oxygen-containing gas must be sufficient to attain T_{Rx} upon combination with the metal chloride and scrubs steams, considering the temperatures, compositions and flow rates of those streams as well as heat losses. T_{Rx} will depend upon the composition of the metal chloride-containing stream and typically ranges from 400° C. to 800° C. Useful oxygen temperatures would typically be in the range of 1000° C. to 2500° C. The oxygen-containing gas should contain at least, or more than, the amount of oxygen needed to stoichiometrically oxidize the metal chlorides. It may contain, in addition, inert gases such as nitrogen and argon and/or recycled product gases such as chlorine, carbon monoxide, and carbon dioxide.

The reactor pipe 4 is also typically refractory-lined to minimize heat loss.

In a preferred embodiment, non-reactive scrub solids can be introduced at a location 20 shown in FIG. 3 to allow the scrub solids to mix with and approach the velocity of the oxygen-containing gas. In feed pipe 2 the velocity of the oxygen-containing gas is equal to or greater than the minimum conveying velocity of the scrub solids.

A variety of materials and particle sizes may be effective as scrubs. Beach sand or product metal oxide particles in the 1 to 2 mm size range are known to be effective but other materials and particle sizes can be used. The scrubs can be conveniently introduced into the reactor with a conveying gas or gravity flow. The ratio of the weight of the scrub solids to the weight of the metal chlorides is at least 0.05.

In a preferred embodiment shown in FIG. 3, the coaxial metal chloride feed lance 5 is positioned on the centerline of reactor pipe 4. The lance can be made of ceramic or water-cooled metal. If the lance is water-cooled, it is desirable to coat it with a refractory insulator to minimize heat loss.

The velocity, V_{Ox}, of the oxygen-containing gas flowing through the annulus formed by reactor pipe 4 and feed lance 5 must be sufficient to ensure that neither the metal chloride reactants nor metal oxide products accumulate on the reactor wall in the feed zone. The minimum V_{Ox} will depend upon the geometry of the feed zone including the methods of introducing the metal chloride and scrubs streams and the presence of swirl. The minimum V_{Ox} will also depend upon the bulk temperature and the temperature to which the reactor wall is cooled, within the feed zone. Useful velocities range from 200 ft/s to sonic velocity.

The metal chlorides may be fed as vapors or liquids but, most conveniently, are fed as solids entrained in a conveying gas. In that case, the temperature of the metal chloride feed stream can range from ambient up to the maximum temperature at which the feed can be conveyed without sticking. The upper end of the temperature range would be most desirable, from an energy conservation standpoint, if the chlorides are already available at that temperature or can be brought to temperature with recovered heat. The conveying velocity at 7, the point of metal chloride stream injection, should be selected to provide good mixing with the oxygen-containing gas stream. The ratio of the velocity of the metal chloride conveying gas to that of V_{Ox} must be less than 0.5.

Reactor pipe 11, downstream of discharge location 7, is typically a cooled metal pipe resistant to hot chlorine and oxygen. The reactor diameter downstream of metal chloride feed introduction can vary, maintaining adequate velocity to convey the solid reactants and products and to scrub deposits from the walls as fast as they form. The minimum required velocity will be lower when more non-reactive scrubbing media is present but will also depend upon the composition of the metal chloride feed stream, degree of conversion to oxides and the temperature at which the reactor walls are maintained. Without cooling, hard deposits tend to form on the reactor walls, which are difficult to scrub away. Using excessive velocity and wall cooling to minimize deposition causes the temperature of the combined, reacting streams to drop rapidly and also causes excessive pressure drop. To obtain desirable conversion of chlorides to oxides, the combined streams should remain above T_{Rx} for at least 0.1 sec.

In the preferred embodiment of the reactor the mixing zone, extends at least ten reactor diameters from 7, the point at which metal chloride contacts the oxygen-containing gas. In the cooling zone 8 the reactor walls are typically maintained below 150° C. and the velocity is maintained above 200 ft/sec.

To facilitate conversion without excessive heat input, the reactor walls of the downstream cooling zone 12 can be maintained between 250° C. and 400° C. Under these conditions, the velocity of the combined, reacting stream can be allowed to drop to as low as 100 ft/sec.

Downstream of the reactor, the metal chlorides, at least partially converted to chlorine and metal oxides, can be quenched in water to separate the solid products from the chlorine and un-reacted oxygen or the separation can be accomplished in suitable dry separation equipment such as cyclones and filters. The chlorine can be recovered from the un-reacted oxygen by suitable means such as liquefaction or adsorption, and the un-reacted oxygen can be recycled.

### EXAMPLES

### Example 1

A feed stream containing metal chlorides was injected at 4 via a lance to flow concurrently into the center of an axially-flowing stream of pre-heated oxygen-containing gas fed into the reactor at 1 and scrubbing media fed into the reactor at 5 as represented in FIG. 1.

The feed rate of the metal chlorides-containing solids feed was 300 lb/hr. The conveying gas was oxygen fed at a rate of 18 SCFM. The metal chlorides were fed as a stream of solid particles suspended in the conveying gas. The metal chloride feed stream and the oxygen conveying gas were fed at ambient temperature. The resultant velocity of the metal chloride feed stream combined with the conveying gas was 110 ft/sec.

The flow rate of the axially-flowing stream of pre-heated oxygen-containing gas was 150 SCFM. This stream contained 70% oxygen and 30% argon. It was pre-heated to 1450° C. using a plasma torch and was flowing at a velocity of 440 ft/sec. This stream contained over 1200% excess oxygen needed for stoichiometric oxidation of the metal chlorides.

The scrubbing media of silica sand was fed at a rate of 30 lbs/hr into the pre-heated oxygen-containing gas upstream of the metal-chloride containing feed addition. The mix temperature of the metal chloride feed stream, conveying gas feed stream, pre-heated oxygen containing gas, and scrubbing media stream was 960° C. The reactor inside diameter was 2″ and 3″. That is, a smaller diameter in the portion following the feed zone and a larger diameter at the feed end and at the exit end. In this Example, the reactor length (from end to end) was over 40 ft. The reactor pressure was 23 PSIA. The residence time was 0.27 seconds. Conversion of the metal chlorides to metal oxides and chlorine was over 85%. Accumulation rate of adhesive product on the walls of water-cooled reactor spools, averaged over an eight-hour run, was about 0.02 lbs/ft²/hr.

### Example 2

A metal chloride feed stream of particles suspended in a conveying gas was injected at 2 through a tee mixer into a stream of pre-heated oxygen-containing gas fed into the reactor at 1 and scrubbing media fed into the reactor at 3 as represented in FIG. 2. The feed rate of the metal chlorides was 370 lb/hr. The conveying gas was 20 SCFM of nitrogen. The metal chloride feed stream and the nitrogen conveying gas were fed at ambient temperature. The resultant velocity of the metal chloride feed stream combined with the conveying gas was 70 ft/sec.

The flow rate of the pre-heated oxygen-containing gas stream was 135 SCFM. It was pre-heated to 1450° C. using a plasma torch. This stream contained 100% oxygen and was flowing at a velocity of 440 ft/sec. This stream contained over 1300% excess oxygen needed for stoichiometric oxidation of the metal chlorides.

The scrubbing media of silica sand was fed at a rate of 60 lb/hr to the pre-heated oxygen-containing gas upstream of the metal-chloride containing feed addition. The mix temperature of the metal chloride feed stream, conveying gas feed stream, pre-heated oxygen containing gas, and scrubbing media stream was 640° C. The reactor inside diameter was 2″ and 3″. The reactor length was over 40 ft. The reactor pressure was 20 PSIA. The residence time was 0.23 seconds. Conversion of the metal chlorides to metal oxides and chlorine was about 55%. Accumulation of adhesive product on the walls of water-cooled reactor spools during an almost eight-hour run was minimal until scrubbing media flow was lost.

### Example 3

Two experiments, A and B, compared the effect of wall temperature on the rate of wall deposit accumulation. In each case accumulation rate data were taken in one foot-long test spools located 7 feet downstream of the metal chlorides feed point. The spools were located 7 feet down stream of the metal chloride feed point since the feed streams are known to be well mixed in this region of the reactor. In experiment A, the test spool was cooled with water while in experiment B an air-cooled test spool was used, allowing higher wall temperatures. In both cases, 80 to 90% metal chloride conversions were measured at the end of the reactor while processing 350 pounds per hour of metal chloride-containing feed over a period of about four hours. The following data were recorded:

Experiment

| | | A | B |
|---|---|---|---|
| Inside Wall | ° C. | 130 | 350 |
| Temperature | (estimated) | | |
| Bulk Temperature | ° C. | 880 | 860 |
| Bulk Velocity | Ft/s | 146 | 140 |
| Sand scrubs rate | Pounds/hour | 96 | 70 |
| Deposit rate | Pounds/ft²/hr | 0.017 | <0.004 |

In the above Table, the inside wall temperature was estimated from heat transfer calculations using the Bulk temperature, cooling gas flow rate and inlet and outlet temperature of the cooling gas. Bulk temperature, sand scrubs feed rate and deposit rate were measured. Bulk velocity was calculated from the measured gas feed rates, reactor geometry, and the temperature and pressure in the reactor.

Because of the high surface to volume ratio in a small-scale reactor, cooled walls could not be used throughout. Insulated walls were used for most of the balance of the reactor in all examples. Typical deposition rates in those portions of the reactor, where wall temperatures normally exceeded 600° C., were 0.3 to 0.5 lbs/ft²/hr.

What is claimed is:

1. A process for recovering chlorine by oxidizing a stream comprising metal chlorides, comprising the steps of:
(a) feeding a pre-heated oxygen containing gas into one end of a tubular reactor;
(b) contacting the pre-heated oxygen containing gas at temperature T_{Ox} and velocity v_{Ox} with the stream comprising metal chlorides at temperature Tₘₓ and velocity _{Vmx} wherein the metal chlorides are selected from the group consisting of iron chlorides and mixtures of transition, alkali and alkaline-earth metal chlorides existing in the form of entrained solids, entrained liquids, vapors and mixtures thereof;
(c) introducing non-reactive scrubbing media at temperature Tₛ and velocity vₛ into the reactor; and
(d) at least partially reacting the pre-heated oxygen containing gas with the stream comprising metal chlorides, wherein the walls of the tubular reactor are cooled externally to a temperature range of from about 0 to 500° C. and wherein the temperature of the combined oxygen containing gas, metal chlorides and scrubbing media streams is greater than temperature T_{Rx}, the minimum temperature required to initiate oxidation of the metal chlorides and wherein the combination of v_{Ox}, vₘₓ and vₛ provides at least enough energy to the scrubbing media to remove wall deposits as fast as the deposits are formed.

2. The process of claim 1 wherein the walls of the tubular reactor are cooled to a temperature of from 150 to 500° C.

3. The process of claim 1 wherein a substantial portion of the walls of the tubular reactor are cooled to a temperature of from 250 to 400° C.

4. The process of claim 1 wherein the walls of the reactor are cooled in two or more stages to intermediate temperatures of from 0 to 500° C.

5. The process of claim 1 wherein the temperature T_{Rx} is sustained for at least 0.1 seconds after the pre-heated oxygen-containing gas contacts the stream containing the metal chlorides.

6. The process of claim 1 wherein the scrubbing media is fed into the reactor at one or more positions wherein the positions are selected from the group consisting of (a) one or more positions located between the position where the pre-heated oxygen containing gas enters the reactor and the position where the pre-heated oxygen containing gas and stream comprising metal chlorides are contacted, (b) one or more positions located downstream of the location where the stream comprising metal chlorides is fed into the reactor, and (c) a position or positions where the scrubbing media is fed simultaneously with the stream comprising the metal chlorides.

7. The process of claim 6 wherein immediately downstream of the position where the stream comprising metal chlorides is fed into the reactor, a purge gas is introduced through a purged wall of the reactor.

8. The process of claim 1 wherein the scrubbing media is selected from the group consisting of SiO2, ZrO2, TiO2, Fe2O3, beach sand, titanium ore, olivine, garnet, titanium carbide, dolomite, petroleum coke, salt, and like materials.

9. The process of claim 1 wherein the pre-heated oxygen containing gas is heated to a temperature of from 1000 to 2500° C.

10. The process of claim 1 wherein the pre-heated oxygen containing gas is heated directly or indirectly.

11. The process of claim 1 wherein the pre-heated oxygen containing gas is heated by a burner, a pebble heater, electrical resistance heater, and plasma torch.

12. The process of claim 1 wherein the stream comprising metal chlorides is added by one or more means selected from the group consisting of a tee mixer, an axial slot, a radial slot, and a coaxial center-feed nozzle.

13. The process of claim 1 further comprising introducing a first conveying gas with the scrubbing media and a second conveying gas with the stream comprising metal chlorides and wherein the combination of the pre-heated oxygen containing gas, and the first and second conveying gases forms a bulk gas in the reactor.

14. The process of claim 13 wherein the bulk gas has a velocity V_{b} sufficient to remove wall deposits as fast as such deposits are formed.

15. The process of claim 13 wherein the first and second conveying gas is selected from the group of gases consisting of oxygen, process product gas, nitrogen, carbon monoxide, carbon dioxide, inert gases and mixtures thereof.

16. The process of claim 1 wherein the oxygen content of the oxygen containing gas is at least the amount needed to stoichiometrically oxidize the metal chlorides content present in the stream comprising metal chlorides.

17. The process of claim 1 wherein the stream containing metal chlorides is injected concurrently into the center of an axially-flowing stream of pre-heated oxygen containing gas and scrubbing media.

18. The process of claim 17 wherein the position and relative geometry where the preheated oxygen is fed into the reactor relative to the position where the pre-heated oxygen containing gas and the stream comprising metal chlorides are contacted is modified to impart a swirl component into the velocity of the preheated oxygen containing gas.

19. The process of claim 1 wherein the ratio of the weight of scrubbing media to the weight of metal chlorides present in the stream comprising metal chlorides is at least 0.05.

20. The process of claim 17 or 18 wherein the ratio of the velocity of the oxygen containing gas to that of the metal chloride conveying gas is at least 2 to 1.

21. A tubular reactor useful in the recovery of chlorine from a stream comprising metal chlorides, the reactor having a feed end and an exit end separated by a length of wall having a diameter D and wherein disposed in the wall near the feed end of the reactor are two or more means for feeding two or more feed streams comprising (a) a first stream comprising hot oxygen, (b) a second stream comprising scrubbing media, and (c) a third stream comprising a metal chloride stream wherein the third stream is fed through a third means for feeding or fed simultaneously with the scrubbing media and wherein the reactor includes a means for pre-heating at least one of the feed streams and wherein the diameter D is varied along the length of wall of the reactor and wall temperature is controlled by an external cooling means at least over a portion of the wall's length.

22. The reactor of claim 21 wherein the stream comprising metal chlorides is fed by one or more means selected from the group consisting of a tee mixer, an axial slot, a radial slot, and a coaxial center-feed nozzle.

23. The reactor of claim 21 wherein the scrubbing media particles are fed by one or more means selected from the group consisting of a tee mixer, an axial slot, a radial slot, and a coaxial center-feed nozzle.

24. The reactor of claim 21 wherein a portion of the reactor's wall is a purged wall.

25. The reactor of claim 20 wherein the gas comprising hot oxygen is fed first into the reactor, followed by scrubbing media forming a combined feed stream of hot oxygen gas and scrubbing media which is then contacted by the feed stream comprising metal chlorides.

26. The reactor of claim 21 wherein the scrubbing media is fed into the reactor at one or more positions wherein the positions are selected from the group consisting of (a) one or more positions located between the position where the preheated oxygen containing gas enters the reactor and the position where the pre-heated oxygen containing gas and stream comprising metal chlorides are contacted, (b) one or more positions located downstream of the location where the stream comprising metal chlorides is fed into the reactor, and (c) a position or positions where the scrubbing media is fed simultaneously with the stream comprising the metal chlorides.

27. The reactor of claim 21 wherein the walls are cooled by means of a jacket having one or more pair of inlets and outlets through which one or more cooling fluids are circulated to control the wall temperature.

28. The reactor of claim 21 wherein the means of pre-heating gas is selected from the group consisting of a burner, a pebble heater, electrical resistance, heater and plasma torch.
